(19) United States
(12) Patent Application Publication
(10) Pub. No.: US 2008/0257980 A1
(43) Pub. Date: Oct. 23, 2008

(54) Fuel Injector

(76) Inventor: Hans-Christoph Magel, Reutlingen (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/094,243

(22) PCT Filed: Oct. 27, 2006
(86) PCT No.: PCT/EP2006/067848

§ 371 Date: May 19, 2008

(30) Foreign Application Priority Data
Dec. 13, 2005 (DE) 10 2005 059 437.9

(51) Int. Cl. F02M 47/02

(52) U.S. Cl. 239/89; 239/102.2; 123/472

(57) ABSTRACT

The invention relates to a fuel injector having an injector housing containing a pressure chamber from which highly pressurized fuel is injected into a combustion chamber of an internal combustion engine. A nozzle needle control chamber is provided in the housing such that a nozzle needle has its first end disposed in the nozzle needle control chamber. A second end of the nozzle needle lifts away from its seat as a function of the pressure in the nozzle needle control chamber. The pressure in the nozzle needle control chamber is controlled by a switching valve device which is equipped with a piezoelectric actuator that expands longitudinally when supplied with current. A valve piston is coupled to the piezoelectric actuator and has its free end of the disposed in a valve piston control chamber. The valve piston control chamber communicates with the nozzle needle control chamber. In the charged state of the piezoelectric actuator, the free end of the valve piston interrupts a hydraulic pressure-relief connection between the valve piston control chamber and a pressure-relief chamber.

### PRIOR ART

The invention relates to a fuel injector as generically defined by the preamble to claim 1. The nozzle needle control chamber is also referred to as the servo-control chamber. Therefore the fuel injector according to the invention is also referred to as a servo-controlled injector whose servo-control chamber is controlled by the valve device with the piezoelectric actuator.

The object of the invention is to create a fuel injector according to the preamble to claim 1 that has an improved injection performance and can be inexpensively manufactured.

The object is attained by a fuel injector according to claim 1. Preferred exemplary embodiments of the invention are disclosed in the dependent claims.

### ADVANTAGES OF THE INVENTION

The exemplary embodiment according to claim 1 offers the advantage that the valve piston is pressure-compensated. This enables the use of small movement forces. In addition, the volume of the piezoelectric actuator can be significantly reduced, thus achieving significant cost savings. According to an essential aspect of the invention, a servo-controlled injector with a control chamber is produced, which for pressure-relief is connected to low pressure via the pressure-relief connection. The piezoelectric actuator functions inversely, i.e. in the idle state of the injector, the piezoelectric actuator is supplied with current and has its nominal longitudinal expansion so that the pressure-relief connection is interrupted. To trigger the injection, the supply of current to the piezoelectric actuator is disconnected, causing the actuator to contract. Then the pressure in the nozzle needle control chamber is relieved into the pressure-relief chamber via the valve piston control chamber and the nozzle needle opens.

In the exemplary embodiment according to claim 2, the valve piston preferably has a comparatively small diameter. Consequently, the leakage-generating guide for the valve piston also has only a relatively small diameter and therefore only a small leakage quantity occurs.

In the exemplary embodiment according to claim 3, the free end of the valve piston preferably has a circumferential sealing edge that cooperates with an associated sealing surface on the valve plate to form a flat seat. The flat seat permits compensation for imprecisions in positioning, but it is also possible to use other seat forms such as ball seats or conical seats.

In the exemplary embodiment according to claim 4, the pressure-relief conduit preferably has a pressure-relief opening that the free end of the valve piston is able to close.

The exemplary embodiment according to claim 5 offers the advantage that the pressure-relief conduit in the valve plate can be eliminated, thus increasing its strength.

In the exemplary embodiment according to claim 6, the first through opening is preferably equipped with an outlet throttle via which the pressure in the nozzle needle control chamber is relieved in order to open the nozzle needle.

In the exemplary embodiment according to claim 7, the second through opening is preferably equipped with an inlet throttle. During the closing of the nozzle needle, the inlet throttle permits a filling of the nozzle needle control chamber via the outlet throttle.

In the exemplary embodiment according to claim 8, a long, one-piece nozzle needle is preferably used.

In the exemplary embodiments according to claims 9 and 10, the material properties are preferably selected so that the temperature expansions of the piezoelectric actuator are precisely compensated for. According to an essential aspect of the invention, the valve piston mechanically contacts the injector housing directly via the piezoelectric actuator and at least one temperature expansion compensation element. The mechanical temperature compensation for the piezoelectric actuator and the inverse operation of the actuator permit a simple structural design of the valve device.

### DRAWINGS

Other advantages, features, and details of the invention ensue from the following description in which two exemplary embodiments are described in detail in conjunction with the drawings.

FIG. 1 shows a longitudinal section through a first exemplary embodiment of a fuel injector according to the invention and

FIG. 2 shows a longitudinal section through a second exemplary embodiment of the fuel injector according to the invention.

### DESCRIPTION OF THE EXEMPLARY EMBODIMENTS

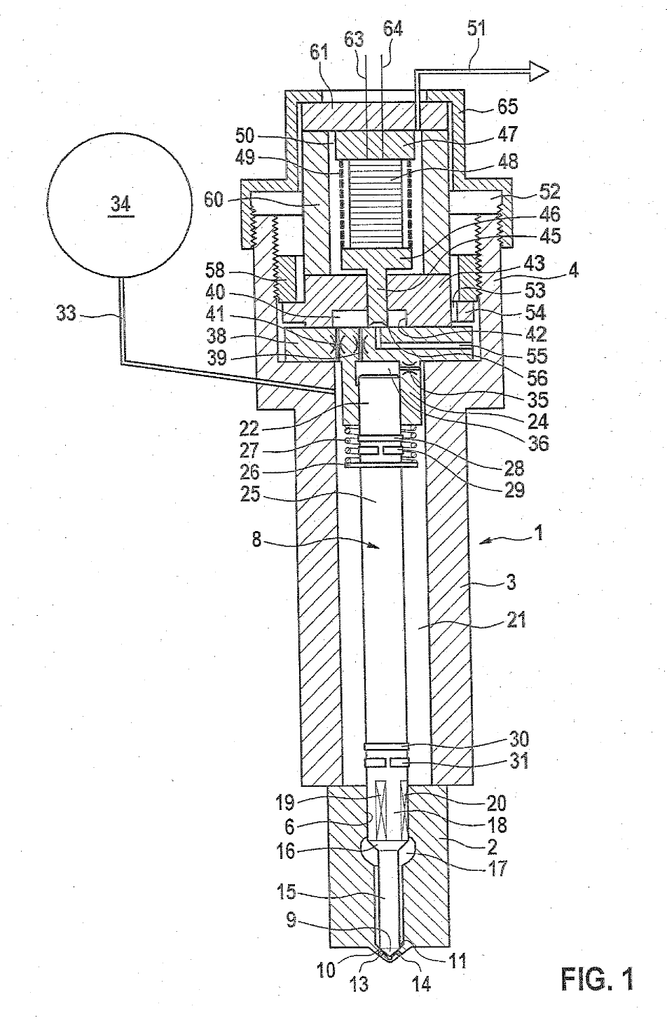

FIG. 1 shows a longitudinal section through a first exemplary embodiment of a fuel injector according to the invention. The fuel injector according to the invention is a so-called common rail injector of a common rail fuel injection system. The fuel injector shown has an injector housing, which is labeled as a whole with reference numeral 1. The injector housing 1 has a nozzle body 2 that protrudes with its lower free end into the combustion chamber of an internal combustion engine to be supplied. The injector housing 1 also has an essentially circular, cylindrical-sleeve-shaped intermediate body 3 and a fastening body 4.

The nozzle body 2 has an axial guide bore 6 let into it in which a nozzle needle 8 is guided in an axially movable fashion. At the tip 9 of the nozzle needle 8, a sealing edge 10 is provided, which cooperates with a sealing surface 11 on the nozzle body 2 to form a sealing seat. When the tip 9 of the nozzle needle 8 rests with its sealing edge 10 in contact with the sealing surface 11, this closes two injection ports 13, 14 in the nozzle body 2. When the nozzle needle tip 9 lifts its sealing edge 10 away from the sealing surface 11, then highly pressurized fuel is injected through the injection ports 13 and 14 into the combustion chamber of the internal combustion engine.

Leading away from the tip 9, the nozzle needle 8 has a pressure chamber section 15 that is embodied essentially in the form of a circular cylinder. The pressure chamber section 15 is followed by a section 16 that widens out in truncated cone fashion and is referred to as a pressure shoulder. The sections 15 and 16 are at least partially situated in a pressure chamber 17 that is formed between the nozzle needle 8 and the nozzle body 2. The section 16 that widens out like a truncated cone is followed by a guide section 18 that is embodied essentially in the form of a circular cylinder and is guided so that it is able to move back and forth in the axial guide bore 6 of the nozzle body 2. Flattened regions 19, 20 embodied in the guide section produce a fluid connection between the pressure chamber 17 and an annular chamber 21.

At its end oriented away from the combustion chamber, the nozzle needle 8 has another guide section 22, which is guided in a nozzle needle guide sleeve 24. Between the two guide sections 18 and 22, a connecting section 25 extends, on which a collar 26 is provided in the vicinity of the guide section 22. A nozzle needle spring 27 is clamped between the collar 26 and the end surface of the nozzle needle guide sleeve 24 oriented toward the combustion chamber. In the vicinity of the guide sections 18, 22, there are two respective pairs of compensation ribs 28, 29 and 30, 31 offset at right angles to one another are provided in the nozzle needle 8. The compensation ribs permit a slight deformation of the nozzle needle 8 in a fashion similar to a universal joint. It is thus possible to avoid undesired stresses on the nozzle needle due to imprecisions in production.

The annular chamber 21 communicates via a high-pressure fuel line 33 with a central high-pressure fuel source 34, e.g. a high-pressure fuel accumulator that is also referred to as a common rail. The nozzle needle guide sleeve 24 has an inlet throttle 35 through which fuel travels in a throttled fashion from the annular chamber 21 into a nozzle needle control chamber 36, which is delimited in the radial direction by the nozzle needle guide sleeve 24. In the axial direction, the nozzle needle control chamber 36 is delimited by the end of the nozzle needle 8 oriented away from the combustion chamber and by a valve plate 38 that is of one piece with the nozzle needle guide sleeve 24.

The valve plate 38 has a through opening 39 provided with an outlet throttle that connects the nozzle needle control chamber 36 to a valve piston control chamber 40. In addition, the valve plate 38 has another through opening 41 provided with a throttle that connects the annular chamber 21 to the valve piston control chamber 40. The valve piston control chamber 40 is constituted by a recess 42 in a guide element 43 that is closed by the valve plate 38.

The guide element 43 has a guide bore in which a valve piston 45 is guided so that it is able to move back and forth in the axial direction. The valve piston 45 is connected to a coupling piece 46. A piezoelectric actuator 48 is situated between the coupling piece 46 and another coupling piece 47. The piezoelectric actuator 48 is encompassed in the circumference direction by a tension spring 49 that is mounted between the coupling pieces 46 and 47. The actuator is thus prestressed in the axial direction. Through a suitable compensation behavior, the coupling pieces 46 and 47 permit the compensation of temperature expansions and are therefore also referred to as temperature expansion compensation elements. It is also possible to use only one temperature expansion compensation element.

The piezoelectric actuator 48 is situated inside a pressure-relief chamber 50 that communicates with a return reservoir (not shown) via a return line 51. The pressure-relief chamber 50 communicates with an additional pressure-relief chamber 52 situated radially outside the pressure-relief chamber 50. The pressure-relief chamber 52 communicates with a pressure-relief conduit 55 via a through opening 53 provided in a collar 54 extending out from the guide element 43. The piezoelectric actuator is directly surrounded by fuel in the low-pressure region, thus achieving a favorable thermal coupling between the piezoelectric actuator and the temperature compensation elements. If only one compensation element 46 is used, then it is possible to achieve a uniform thermal distribution in the actuator and the compensation element. The actuator is protected from the fuel by a suitable measure, e.g. by being provided with a coating.

The pressure-relief conduit 55 extends from the pressure-relief chamber 52 through the valve plate 38 into the valve piston control chamber 40. The opening of the pressure-relief conduit 55 into the valve piston control chamber 40 is closed by the end of the valve piston 45 oriented toward the combustion chamber. A sealing seat 56 prevents the escape of fuel from the valve piston control chamber 40 through the pressure-relief conduit 55 into the pressure-relief chamber 52. During the idle state of the fuel injector, current is supplied to the piezoelectric actuator 48 and the sealing seat 56 is closed. In order to trigger an injection, the supply of current to the piezoelectric actuator 58 is interrupted, causing it to contract. Then the sealing seat 56 opens and the pressure in the valve piston control chamber 40 is relieved into the pressure-relief chamber 52 via the pressure-relief conduit 55 so that the nozzle needle 8 opens. The sealing seat 56 of the valve piston 45 and the guide of the valve piston 45 in the guide section 43 have exactly or virtually the same diameter so that the valve piston 45 is pressure-compensated in relation to the pressure chamber 40 and is subjected to only a slight compressive force.

A threaded ring 58 that engages the collar 54 holds the guide element 43 in sealed contact with the valve plate 38, which is clamped between the guide element 43 and the intermediate body 3. The fastening body 4 is of one piece with the intermediate body 3. The nozzle body 2 can also be of one piece with the intermediate body 3. The piezoelectric actuator 48 is encompassed by an actuator housing 60 that is situated between the guide element 43 and the actuator housing cover 61. Electrical connection lines 63 and 64 that supply current to the piezoelectric actuator 48 extend through the coupling piece 47 and the actuator housing cover 61. A union nut 65 that is screwed onto the fastening body 4 from the outside clamps the actuator housing 60 and the actuator housing cover 61 against the guide element 43. The coupling piece 47 and the housing cover 61 can also be of one piece with each other.

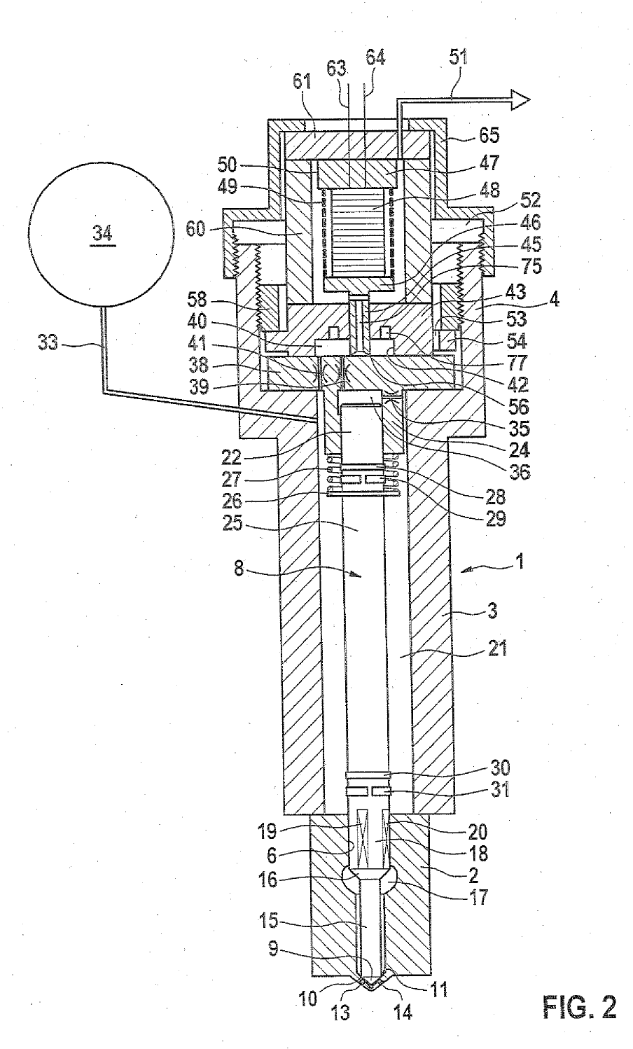

FIG. 2 shows a longitudinal section through a second exemplary embodiment of an injector according to the invention. Parts that remain the same have been labeled with the same reference numerals. In order to avoid repetition, to the reader is hereby referred to the above description of FIG. 1. The description below is limited solely to the differences between the two exemplary embodiments.

In the exemplary embodiment show in FIG. 2, a pressure-relief conduit 75 extends through the valve piston 45. As soon as the valve piston 45 lifts away from the sealing seat 56 of the valve plate 38, the pressure in the valve piston control chamber 40 is relieved into the pressure-relief chamber 50 via the pressure-relief conduit 75. Situating the pressure-relief conduit 75 in the valve piston 45 makes it possible to eliminate the pressure relief conduit in the valve plate (see FIG. 1). This increases the strength of the valve plate. Counterpressure regions 77 are provided in the guide element 43, radially outside the valve piston 45. This makes it possible to prevent expansion of the guide element 43 caused by the fuel pressure in the valve piston 45 and also makes it possible to reduce the leakage quantity.

1-10. (canceled)

11. A fuel injector comprising:
an injector housing;
a pressure chamber from which highly pressurized fuel is injected into a combustion chamber of an internal combustion engine;
a nozzle needle control chamber;
a nozzle needle having a first end disposed in the nozzle needle control chamber and a second end which lifts away from its seat as a function of the pressure in the nozzle needle control chamber;
a switching valve device controlling the pressure in the nozzle needle control chamber, the switching valve device being equipped with a piezoelectric actuator that expands longitudinally when supplied with current;
a valve piston coupled to the piezoelectric actuator; and
a valve piston control chamber having a free end of the valve piston disposed therein, wherein the valve piston control chamber communicates with the nozzle needle control chamber, and, in the charged state of the piezoelectric actuator, the free end of the valve piston interrupts a hydraulic pressure-relief connection between the valve piston control chamber and a pressure-relief chamber.

12. The fuel injector according to claim 11, wherein a guide element, which partially delimits the valve piston control chamber, guides the valve piston so that it is able to move back and forth.

13. The fuel injector according to claim 11, wherein during a charged state of the piezoelectric actuator, the free end of the valve piston comes into contact with a valve unit valve plate situated between the nozzle needle control chamber and the valve piston control chamber.

14. The fuel injector according to claim 12, wherein during a charged state of the piezoelectric actuator, the free end of the valve piston comes into contact with a valve unit valve plate situated between the nozzle needle control chamber and the valve piston control chamber.

15. The fuel injector according to claim 13, wherein the valve plate has a pressure-relief conduit that connects the valve piston control chamber to a pressure-relief chamber when the valve piston lifts away from the valve plate.

16. The fuel injector according to claim 14, wherein the valve plate has a pressure-relief conduit that connects the valve piston control chamber to a pressure-relief chamber when the valve piston lifts away from the valve plate.

17. The fuel injector according to claim 13, wherein the valve piston has a pressure-relief conduit that connects the valve piston control chamber to a pressure-relief chamber when the valve piston lifts away from the valve plate.

18. The fuel injector according to claim 14, wherein the valve piston has a pressure-relief conduit that connects the valve piston control chamber to a pressure-relief chamber when the valve piston lifts away from the valve plate.

19. The fuel injector according to claim 13, wherein the valve plate has a first through opening that connects the nozzle needle control chamber to the valve piston control chamber.

20. The fuel injector according to claim 14, wherein the valve plate has a first through opening that connects the nozzle needle control chamber to the valve piston control chamber.

21. The fuel injector according to claim 15, wherein the valve plate has a first through opening that connects the nozzle needle control chamber to the valve piston control chamber.

22. The fuel injector according to claim 17, wherein the valve plate has a first through opening that connects the nozzle needle control chamber to the valve piston control chamber.

23. The fuel injector according to claim 13, wherein the valve plate has a second through opening that connects a high-pressure chamber to the valve piston control chamber.

24. The fuel injector according to claim 14, wherein the valve plate has a second through opening that connects a high-pressure chamber to the valve piston control chamber.

25. The fuel injector according to claim 15, wherein the valve plate has a second through opening that connects a high-pressure chamber to the valve piston control chamber.

26. The fuel injector according to claim 17, wherein the valve plate has a second through opening that connects a high-pressure chamber to the valve piston control chamber.

27. The fuel injector according to claim 13, further comprising a guide sleeve in which an end of the nozzle needle is guided and which delimits the nozzle needle control chamber.

28. The fuel injector according to claim 14, further comprising a guide sleeve in which an end of the nozzle needle is guided and which delimits the nozzle needle control chamber.

29. The fuel injector according to claim 11, further comprising a temperature expansion compensation element composed of a material that changes length under the influence of temperature, the temperature expansion compensation element being disposed between the injector housing and an end of the piezoelectric actuator oriented away from the valve piston, the temperature expansion compensation element compensating for a temperature-induced length change of the piezoelectric actuator.

30. The fuel injector according to claim 11, further comprising a temperature expansion compensation element composed of a material that changes length under the influence of temperature, the temperature expansion compensation element being disposed between the piezoelectric actuator and valve piston, the temperature expansion compensation element compensating for a temperature-induced length change of the piezoelectric actuator.
